(19) United States
(12) Patent Application Publication
(10) Pub. No.: US 2011/0102191 A1
(43) Pub. Date: May 5, 2011

(54) Method and device for operating a night vision system for cars

(76) Inventors: Helmuth Eggers, Sindelfinfen (DE); Gerhard Kurz, Wendlingen (DE); Juergen Seekircher, Ostfildem (DE); Thomas Wohlgemuth, Aichtal (DE)

(21) Appl. No.: 10/532,620

(22) PCT Filed: Oct. 17, 2003
(86) PCT No.: PCT/EP2003/011517

§ 371 Date: Nov. 24, 2006

(30) Foreign Application Priority Data
Oct. 24, 2002 (DE) 102 49 816.4

(51) Int. Cl. B60Q 1/00; H04N 7/18

(52) U.S. Cl. 340/901; 348/148; 340/425.5; 348/E07.085

(57) ABSTRACT

Poor visibility at night is a tiring and dangerous situation in traffic, feared by many drivers. As a result of poor visibility, the frequency of accidents at night is significantly higher than during the day with good visibility conditions. Cars are thus prospectively fitted with night vision systems, in order to increase safety in traffic. A night vision system used for this purpose generally comprises an illumination unit for illuminating the environment surrounding the vehicle, an image recording unit for collecting environmental data, and an image processing unit for evaluating the environmental data. So that the operation of the night vision system can be adapted to different situations, it must be designed in a flexible manner. To this end, the individual components of the night vision system must be able to be operated in different combinations. In order to achieve this, the components of the night vision system can be individually controlled by means of at least one control signal.

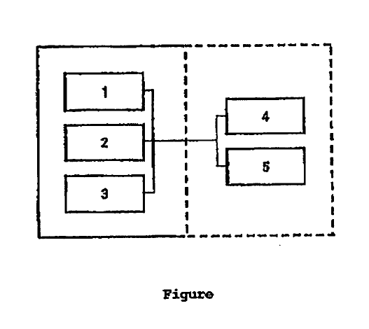

### CROSS REFERENCE TO RELATED APPLICATION

This application is a national stage of PCT/EP2003/011517 filed Oct. 17, 2003 and based upon DE 102 49 816.4 filed Oct. 24, 2002 under the International Convention.

### BACKGROUND OF THE INVENTION

1. Field of the Invention

The invention relates to a method for operation of an automobile night vision system, and to an apparatus for use of the method for operation of an automobile night vision system.

2. Description of Related Art

Poor visibility at night is a stress-creating and dangerous situation in road traffic, which is feared by many drivers. As a consequence of poor visibility, the accident probability at night is considerably higher than when driving in the daytime and in good visibility. In the future, automobiles will be equipped with night vision systems in order to improve road traffic safety. The night vision systems which will be used for this purpose normally operate in the near infrared wavelength band (NIR). Since the radiation from the NIR headlights which are used in conjunction with automobile night vision systems is invisible to the human eye, this represents a danger against which people must be protected. However, protection against the NIR radiation is only one reason why night vision systems can be operated only in very specific conditions.

A system for assisting the driver's visual capabilities when driving at night is proposed on the Toyota Motor Corporation Internet page www.toyota.co.jp/Showroom/All toyota lineup/LandCruiserCygnus/safety/index.html. When dipped headlights are switched on, the system shows the road profile, which is difficult to see in front of the light beam of the vehicle, and the objects located in the surrounding area. The system also provides assistance to long-distance vision, in particular in situations in which it is impossible to drive on main beam. In this case, the night vision system uses invisible near infrared rays, which are not perceived by the human eye. The energy, which is invisible to the human eye, is recorded by an IR camera fitted in the vehicle, and is processed to form an image. The processed image is then projected by means of a head-up display onto the vehicle windshield.

### SUMMARY OF THE INVENTION

For safety reasons, the “Night-View” system must not be used as the sole source of vision. The system safety can in this case be adversely affected by a large number of factors, such as rain, a dirty windshield, poorly reflective clothing, etc.

Furthermore, there is the possibility of danger to people in the vicinity of the vehicle as a result of the invisible radiation from the IR illumination, for which reason the infrared transmitter should not be looked at for a lengthy period from short range.

The following operating conditions must therefore be satisfied at the same time for operation of the night vision system: ignition ON, surrounding area dark, headlights ON, night-view switch ON, and furthermore the speed of travel must be at least 30 km/h. The disadvantage in this case is that the system cannot be designed to be flexible, and cannot be operated such that it is adapted to different situations.

The invention is thus based on the object of providing a novel method for operation of an automobile night vision system, as well as an apparatus for use of the method as claimed, which allows the night vision system to be designed to be flexible, and allows the system to be operated such that it is matched to different situations.

According to the invention, a night vision system is operated on a vehicle. The night vision system in this case has an illumination unit for transmission of infrared radiation, by which means the surrounding area in front of the vehicle is preferably illuminated. The infrared radiation which is reflected on the road surface and on other objects is detected by means of an image recording unit which is sensitive to the infrared wavelength band. An image processing unit is provided for evaluation of the detected data from the surrounding area. In this case, the purpose of the image processing unit is not only to convert the data from the surrounding area to an image, but also to allow object identification to be carried out.

The components of the night vision system can be driven individually in a particularly advantageous manner by means of at least one control signal. In this case, the control signal may, for example, be a control signal which is generated by an image processing unit, by an image recording unit, by further vehicle-internal systems or by user inputs (for example by means of a pushbutton or foot-operated switch). It is thus possible to operate the individual components of the night vision system in different constellations. The invention therefore also for the first time makes it possible to operate the night vision system such that it is flexibly matched to different situations. In this case, all of the operating conditions need not necessarily be satisfied at the same time for operation of the individual components of the night vision system in different constellations.

In one embodiment of the invention that results in an improvement, an optical display is provided as an additional component for the night vision system. The optical display is used primarily to display information from the surrounding area detected by means of the IR camera. The optical display furthermore makes it possible to display other information produced by the image processing unit, as well. For example, this may be image data which represents object data or distance data. The optical display can be designed to be a head-up display in this case. An embodiment is also feasible in which a display is integrated in the vehicle cockpit, for the optical display.

In a further embodiment of the invention which results in an improvement, the night vision system is additionally equipped with an interface. The night vision system can interchange information with vehicle-internal systems via the interface. In this case, on the one hand, vehicle-internal systems can activate the components of the night vision system while, on the other hand, individual components of the night vision system can also transmit control signals to vehicle-internal systems.

By way of example, a navigation appliance which is fitted in the vehicle can activate the night vision system automatically at the appropriate time when the vehicle is approaching a tunnel, and shortly before driving into the tunnel, on the basis of information from digital maps.

The image data which is detected by means of the camera of the night vision system (with the camera advantageously being located in the area which is cleaned by the windshield and/or headlight cleaning system) can be evaluated in order to detect dirt on the windshield or headlights, and then to transmit a control signal to the control unit for the windshield and headlight cleaning system, and to activate the headlight cleaning system. The configuration of the night vision system need not include an optical display for this purpose.

A further option is for the image processing unit to transmit a control signal to the control unit for the airbag devices on the basis of a danger situation having been identified, and in this way to preactivate these devices.

In principle, it is feasible to transmit control signals from the night vision system to warning devices, in which case, for example, the warning signal may also be represented by means of a spoken output.

It is particularly advantageous for the optical display to be automatically deactivated if the image data produced by the image processing unit is not automatically updated within a fixed predetermined time interval. Otherwise, the driver would be unnecessarily irritated by the displayed image not following the area surrounding the vehicle but being displayed as a stationary image. Alternatively, it would also be feasible, instead of deactivating the optical display, to deliberately display a fault message on the optical display. In order to allow such functionality, the control signal is in this case represented by the image data produced by the image processing. The control signal thus changes with the change in the displayed image data. If this control signal does not change within a predetermined time interval, this initiates the deactivation of the optical display.

In one advantageous embodiment of the invention, the night vision system is designed such that, in the situation where the control signal for operation of the night vision system is not requested automatically by vehicle-internal systems, but is requested manually by the driver, a change takes place in any case to the night vision display on the display unit. However, this is also the case when other conditions which are required for operation of the night vision system are not satisfied. For example, in this case as well, a change takes place to the night vision display when the vehicle is not moving and, in consequence, the infrared illumination cannot be activated for safety reasons. It is thus obvious to the driver that all of the necessary conditions for correct operation of all of the components of the night vision system are not satisfied, and that this is not a malfunction of the night vision system.

In a further advantageous refinement of the invention, it is feasible for all of the individual components, in particular the illumination unit and the image recording unit, of the night vision system to be used in order to communicate in the infrared wavelength band with other vehicles or traffic facilities. In this case, it is particularly advantageous for the night vision system to be configured such that it does not have an optical display. In this case, the optical display is not switched on, and the driver is thus not disturbed.

In addition, in the situation where vehicle-internal systems generate a control signal for operation of individual components of the night vision system, all of the components of the night vision system are included in the configuration, with the exception of the optical display. For example, a system which is based on radar signal processing for spacing control, or an image processing system for object identification, can request the functionality of the night vision system, with no optical display being required in this case, and thus without the driver being distracted.

In situations in which a configuration which includes the optical display has already been active and communication is intended to be set up with other vehicles or traffic facilities or with vehicle-internal systems, the optical display remains in that configuration, and is not removed.

A request for the night vision functionality may be requested both manually by the driver and by vehicle-internal systems. It is advantageous for the night vision system to be configured in such a way that it is activated in any case in the event of a request such as this for the night vision functionality. The components of the night vision system are also activated in circumstances in which no night vision functionality would be required; for example during the daytime or when the vehicle is stationary. The IR illumination unit is, however, switched on only as a function of other operating conditions, in order not to endanger other road users. The operating conditions for infrared illumination include dipped headlights having to be switched on, since the night vision system is otherwise not required. Furthermore, the vehicle must be moving at a predetermined minimum speed in order that no one can look directly into the IR illumination unit for a long time. However, for diagnosis purposes, the IR illumination unit can also be switched on separately by means of a special facility, when stationary.

In a further embodiment of the invention which results in an improvement, the night vision system may be configured such that all of the components can be activated individually, independently of the operating conditions. This is advantageous, for example, when a control signal for activation of the components of the night vision system is generated by means of vehicle-external diagnosis systems in workshops. The information interchange with vehicle-external diagnosis systems in this case takes place via vehicle-internal systems.

### BRIEF DESCRIPTION OF THE DRAWING

The single FIGURE shows the schematic layout of an automobile night vision system.

### DETAILED DESCRIPTION OF THE INVENTION

By way of example, the FIGURE shows the schematic layout of an automobile night vision system. In this case, the night vision system comprises an illumination unit (1) for illumination of the area surrounding the vehicle with infrared light. An image recording unit (2) which has a receiver which receives in the infrared wavelength band is used for scanning the area surrounding the vehicle, and for then converting this information to image data. The night vision system furthermore has an image processing unit (3), by means of which the image data can be evaluated and can be preprocessed for optical display. For optical display purposes, the night vision system is equipped with a display unit (4) which projects the image data onto the front windshield, for example, or presents it on a display in the cockpit of the vehicle. For information interchange with other components, an interface (5) to vehicle-internal systems is also provided.

1. A method for operation of an automobile night vision system having two or more components, comprising
an illumination unit for the illumination of the area surrounding the vehicle,
an image recording unit for the recording of data from the surrounding area,
an image processing unit for the evaluation of data from the surrounding area,
wherein the components of the night vision system are operated in different constellations on the basis of at least one control signal.

2. The method as claimed in claim 1,
wherein an optical display is used as an additional component in order to display information from the surrounding area as well as further information from image data produced by the image processing unit.

3. The method as claimed in claim 1,
wherein the night vision system interchanges information with vehicle-internal systems, and a suitable interface is used as an additional component for this purpose.

4. The method as claimed in claim 2, wherein in the situation where the control signal is represented by the image data supplied from the image processing unit,
and the optical display is switched off automatically, if the control signal has not changed within a predetermined time interval, in order to avoid irritation.

5. The method as claimed in claim 2, wherein in the situation where the control signal is generated on the basis of a request for the night vision functionality by the driver, the optical display is activated in any case, in order to avoid irritation.

6. The method as claimed in one of claim 2, wherein in the situation where the control signal is generated on the basis of communication with other vehicles and/or traffic facilities, and communication is intended to take place using components of the night vision system, the optical display is not switched on, in order to avoid distracting the driver.

7. The method as claimed in claim 1,
wherein in the situation where the control signal is generated by vehicle-internal systems, the night vision system is switched on, with the optical display remaining off, in order to avoid distracting the driver.

8. The method as claimed in claim 1,
wherein in the situation where the control signal is generated on the basis of a request for the night vision functionality by the driver or by further vehicle-internal systems, as a result of which the night vision system is activated in any case, the illumination unit is switched on only as a function of further operating conditions, in order not to endanger others in the traffic.

9. The method as claimed in claim 1,
wherein in the situation where the control signal is generated on the basis of a vehicle-internal system which is connected to a vehicle-external diagnosis system,
all of the components of the night vision system and the optical display can be activated independently of the operating conditions,
and information can be interchanged between these components and vehicle-internal systems.

10. An apparatus for operation of an automobile night vision system having two or more components, comprising
an illumination unit for illumination of the area surrounding the vehicle,
an image recording unit for recording of data from the surrounding area,
an image processing unit for evaluation of data from the surrounding area,
wherein the components of the night vision system are operated in different constellations on the basis of at least one control signal.

11. The apparatus as claimed in claim 10,
wherein the night vision system has an optical display as an additional component.

12. The apparatus as claimed in claim 10,
wherein the night vision system has an interface to vehicle-internal systems as an additional component.
